(19) United States
(12) Patent Application Publication
(10) Pub. No.: US 2004/0043139 A1
(43) Pub. Date: Mar. 4, 2004

(54) Printer and method for manufacturing electronic circuits and displays

(76) Inventor: John James Daniels, Higganum, CT (US)

Correspondence Address: John J. Daniels, Esq, 511 Foot Hills Road, Higganum, CT, 06441, US

(21) Appl. No.: 10/234,301

(22) Filed: Sep. 4, 2002

(51) Int. Cl. B05D 5/06

(52) U.S. Cl. 427/66

(57) ABSTRACT

A printer for forming an electronic device utilizing microencapsulated electrically active material. A locally variable attractive field member is provided for selective attracting field attractive microcapsules. The locally variable attractive field member is controlled to selectively apply an attractive field at locations so that a layer of field attractive microcapsules can be formed. The field attractive microcapsules comprise an electrically reactive material. A predetermined electronic circuit component may be formed depending the composition and dimensions of the layer of field attractive microcapsules. The locally variable attractive field member has an optoelectric and/or an optomagnetic coating formed on it for generating an attractive field in response to light impinging on the coating. A light beam directed to impinge on the coating generates a magnetic field and/or an electrostatic field in order to form a respective attractive field at corresponding discrete locations on the locally variable attractive field member. A method of forming a thin, lightweight display. A display stratum is formed comprising light emitting pixels for displaying information fabricated by printing conductive polymer microcapsules. Electronic devices are fabricated by printing patterns of electrically reactive microcapsules at discrete locations. A battery stratum fabricated by the inventive printing method provides electrical energy to the display components.

### BACKGROUND OF THE INVENTION

The present invention pertains to a printer and method for manufacturing electronic circuits and displays. More particularly, the present invention pertains to a printer capable of utilizing microencapsulated material to form various electronic circuit elements and display devices, and a method of using field attractive microcapsules for fabricating electronic circuits and displays.

The inventor of the present invention is also the inventor of the innovations described and claimed in U.S. Pat. No. 5,231,450 and U.S. Pat. No. 5,424,822, the disclosure of both are incorporated by reference herein.

Recently, there has been activity in developing thin, flexible displays that utilize pixels of electroluminescent materials, such as organic light emitting diodes (OLEDs). Such displays do not require any back lighting since each pixel element generates its own light. Typically, the organic materials are deposited by spin-coating or evaporation. U.S. Pat. No. 6,395,328, issued to May, teaches an organic light emitting color display wherein a multicolor device is formed by depositing and patterning layers of light emissive material. U.S. Pat. No. 5,965,979, issued to Friend, et al., teaches a method of making a light emitting device by laminating two self-supporting components, at least one of which has a light emitting layer. U.S. Pat. No. 6,087,196, issued to Strum, et al., teaches a fabrication method for forming organic semiconductor devices using ink jet printing. U.S. Pat. No. 6,416,885 B1, issued to Towns et al., teaches an electroluminescent device wherein a conductive polymer layer between an organic light emitting layer and a charge-injecting layer resists lateral spreading of charge carriers to improve the display characteristics. U.S. Pat. No. 6,48,200 B1, issued to Yamazaki et al., teaches a method of manufacturing an electro-optical device using a relief printing or screen printing method. U.S. Pat. No. 6,402,579 B1, issued to Pichler et al., teaches an organic light-emitting device in which a multilayer structure is formed by DC magnetron sputtering. U.S. Pat. No. 6,50,687 B1, issued to Jacobson, teaches an electronically addressable microencapsulated ink and display.

The prior art indicates that organic light-emitting pixels may be formed into a display using various manufacturing techniques. For example, the '196 patent shows that an OLED can be fabricated using an inkjet printer. The '687 patent shows that various electronic circuit elements may be formed from microencapsulated electronically active materials.

The teachings of the prior art show that it is possible to create a thin, lightweight, flexible, bright, display in which OLED pixels are formed using various methods including ink jet printing techniques. However, no prior art addresses the practical requirement of fabricating such a display with an incorporated user input mechanism. Further, no prior art recognizes the need to format and transmit content, such as HTML pages, so that it can be displayed without requiring substantial on-board data processing. Data processing components, such as microprocessors, consume power, are relatively expensive, difficult to manufacture and require complex electrical circuits. Thus, having a thin, bright, wireless display with substantial onboard processing severely limits the effectiveness of the display. Further, there is no prior art that provides such a display fabricated so that it is capable of receiving two or more display information signals simultaneously enabling, for example, a television program to be viewed at the same time that a webpage is displayed. Accordingly, there is a need for a method to manufacture a thin, lightweight, flexible, bright, wireless display which has an effective user input mechanism, is constructed to maximize the power density and efficient power consumption of an onboard battery, and which can be manufactured, at least in part, using printing methods.

### SUMMARY OF THE INVENTION

The present invention overcomes the drawbacks of the conventional art. It is an object of the present invention to provide a printer for forming an electronic device utilizing microencapsulated electrically active material. It is another object of the present invention to provide a method for fabricating a thin, lightweight, bright, wireless display.

In accordance with the present invention, a locally variable attractive field member is provided for selective attracting field attractive microcapsules. The locally variable attractive field member is controlled to selectively apply an attractive field at locations so that a layer of field attractive microcapsules can be formed. The field attractive microcapsules comprise an electrically reactive material. A predetermined electronic circuit component may be formed depending the composition and dimensions of the layer of field attractive microcapsules. The locally variable attractive field member has an optoelectric and/or an optomagnetic coating formed on it for generating an attractive field in response to light impinging on the coating. The coating may be etched into pixels.

A light beam may be directed to impinge on the coating for generating a magnetic field and/or an electrostatic field in order to form a respective attractive field at corresponding discrete locations on the locally variable attractive field member. The directing means may comprise a plurality of fiber optic light guides. The directing means may also comprises a light beam source for generating a light beam and scanning means for scanning the light beam over the at least one optoelectric and optomagnetic coating for generating an attractive field in order to form a respective attractive field at corresponding discrete locations of the at least one optoelectric and optomagnetic coating. The locally variable attractive field member further comprises a light emitting coating on the substrate for generating light, the generated light impinging on at least one of the optoelectric and optomagnetic coating to generate at least one of an electrostatic and magnetic attractive field. The field attractive microcapsules may be magnetically attractive, with the locally variable attractive field member further comprising magnetic field applying means for applying each local attractive field as a magnetically attractive field. The field attractive microcapsules may be electrostatically attractive, with the locally variable attractive field member further comprising electrostatic field applying means for applying each local attractive field as an electrostatically attractive field. At least some of the field attractive microcapsules may include at least one of a thermo-expansive and a heat meltable composition. This enables the fabricated device to have selective density and dimensions which effect the desired electrical characteristics of the fabricated electronic device.

In accordance with the present invention, a method is provided for forming a thin, lightweight display having components capable of being manufactured by a printing method. A support substrate is provided for forming a support structure upon which components can be manufactured by a microcapsule printing method. A display stratum is formed comprising light emitting pixels for displaying information. The light emitting pixels are fabricated by printing a pixel pattern of light-emitting conductive polymer microcapsules. An electronic circuit stratum is formed including electronic devices fabricated by printing patterns of electrically reactive microcapsules at discrete locations on the support substrate. A user input stratum is formed for receiving user input and generating the user input signals, the user input stratum being fabricated by printing a grid of conductive elements. Each conductive element is effective for generating a detectable electrical signal when a magnetic field passes the conductive element. A battery stratum is formed for providing electrical energy to the electronic circuit stratum, user input stratum and display stratum components. The battery stratum may comprise a first current collector layer. An anode layer is printed on the first current collector layer. An electrolyte layer is printed on the anode layer and a cathode layer printed on the electrolyte layer. A second current collector layer printed on the cathode layer.

The display stratum includes printed conductive leads connected with each light emitting pixel for applying the electrical energy selectively to each light emitting pixel under the control of the display driving components. The light emitting pixels are formed by providing an insulative layer, printing a y-electrodes layer comprising lines of a conductive material formed over the insulative layer, printing a pixel layer of light-emitting conductive polymer islands over the y-electrode layer, and printing an x-electrodes layer comprising lines of a transparent conductive material over the pixel layer.

The electronic circuit stratum may include signal receiving components including first radio frequency receiving components for receiving a first display signal having first display information carried on a first radio frequency and second radio frequency receiving components for receiving a second display signal having second display information carried on a second radio frequency. The display driving components include signal processor components for receiving the first display signal and the second display signal and generating a display driving signal. Thus, the inventive display is capable of simultaneously displaying the first display information at a first location on the display stratum and the second display information at a second location on the display stratum. At least some of the components in the battery, display, user input and electronic circuit stratum are formed by printing electrically active material to form circuit elements including resistors, capacitors, inductors, antennas, conductors and semiconductor devices. Other conventionally manufactured circuit components may be mounted, such as by soldering or using a conductive adhesive, to printed conductive lands.

In accordance with the inventive method, a substrate is provided having a top surface for forming a support structure upon which components can be manufactured by a microcapsule printing method. A layer of field attractive microcapsules are attracted to a discrete location of the substrate. The field attractive microcapsules are comprised of electrically reactive material. Thus, a predetermined electronic circuit component may be formed depending the composition and dimensions of the layer of field attractive microcapsules. The electrically active material has the electrical properties of circuit elements such as a conductor, insulator, resistor, semiconductor, inductor, magnetic material, piezoelectric material, optoelectrical material, or thermoelectric material. The layer of field attractive microcapsules may have multiple levels of microcapsules built-up to form a desired three dimensional shape. The electronic circuit component fabricated by the inventive method has electrical properties dependent on the composition of the multiple levels of the built up microcapsule layer and the dimensions of the three dimensional shape.

### BRIEF DESCRIPTION OF THE DRAWINGS

FIG. 1 is a schematic representation of a printer in accordance with the present invention;

FIG. 2(a) is a cross sectional view of an alternative microcapsule supplying means showing containing means and microcapsules dispersed in a fluid prior to the formation of an electronic circuit forming microcapsule layer;

FIG. 2(b) is a cross sectional view of the alternative microcapsule supplying means shown in FIG. 2(a) after the formation of the electronic circuit forming microcapsule layer;

FIG. 3(a) is a cross sectional view of the locally variable attractive field plate having a flat microcapsule layer disposed thereon;

FIG. 3(b) is a schematic representation of a three-dimensional structure of electronic circuit forming microcapsules built up over the flat microcapsule layer on the operable surface of the locally variable attractive field plate, and the irradiation source irradiating image carrying radiation thereon;

FIG. 3(c) is a cross sectional representation of a developed and cured three-dimensional electronic circuit on the locally variable attractive field plate;

FIG. 4(a) is a schematic representation of electronic circuit component forming microcapsules;

FIG. 4(b) is a schematic representation of electronic circuit component forming microcapsules showing the inclusion of an electrolyte inner phase with a conductive polymer shell and a metal inner phase with a conductive polymer shell;

FIG. 4(c) is a schematic representation of black electronic circuit component forming microcapsules and developer microcapsules;

FIG. 4(d) is a schematic representation of a heat meltable microcapsule;

FIG. 5(a) is a perspective view of a portion of the locally variable attractive field plate showing pixels having a relatively weak additional applied field, pixels having a relatively strong additional applied field, and pixels with uniform or no applied field;

FIG. 5(b) is a front plan view of the portion of the locally variable attractive field plate shown in FIG. 5(a) showing the pixels having differing additional applied field strengths;

FIG. 5(c) is a front plan view of the portion of the locally variable attractive field plate showing the build up of a three-dimensional structure of microcapsules attracted to the differing applied field strengths;

FIG. 6(a) is a schematic representation showing the build up of a three-dimensional structure of attracted microcapsules;

FIG. 6(b) is a schematic representation of the build up of a three-dimensional structure of microcapsules being thermally expanded;

FIG. 7 illustrates the inventive thin, lightweight, flexible, bright, wireless display schematically showing the simultaneous display of three received display signals;

FIG. 8 is a schematic representation of the stratum of the inventive thin, lightweight, flexible, bright, wireless display;

FIG. 9 is a representation of an embodiment of the inventive thin, flexible, lightweight, bright, wireless display fabricated using a microcapsule printer;

FIG. 10(a) is a side view of an embodiment of the attractive field member, showing fiber optic light directors for directing light to impinge on an optomagnetic coating applied on a transparent substrate;

FIG. 10(b) is a side view of the embodiment shown in FIG. 10(a), in which the attractive field member further includes a phosphor coating;

FIG. 10(c) is a side view of the embodiment shown in FIG. 10(b), further comprising a light shielding layer;

FIG. 11(a) is a side view of the attractive field member attracting a uniform layer of microcapsules having a flat topography;

FIG. 11(b) is a side view of the attractive field member attracting a non-uniform layer of microcapsules having a varied topography;

FIG. 12(a) is a side view of an embodiment of the attractive field member showing a scanning laser used to write information on an optomagnetic coating;

FIG. 12(b) is an embodiment of the attractive field member, showing a scanning electron gun used to write information on a phosphor coating;

FIG. 12(c) is a side view of an embodiment of the attractive field member, having an LCD matrix, or matrix of diode lasers, used to write information on an optomagnetic coating;

FIG. 12(d) is a front view of the attractive field member shown in FIG. 12(c);

FIG. 13 shows an embodiment in which galvanoscanners are used to scan a laser beam over the attractive field member;

FIG. 14 is an embodiment showing the attractive field member configured as a rotating drum;

FIG. 15(a) is a perspective view showing an embodiment in which an attractive field generating light source is disposed inside a hollow rotating drum;

FIG. 15(b) is a side view of the embodiment of FIG. 15(a) showing microcapsules being attracted and image-wise exposed on the rotating drum;

FIG. 16(a) is an isolated view of a light source configured as an LED or diode laser matrix;

FIG. 16(b) is an isolated view of a light source configured as a liquid crystal light valve;

FIG. 16(c) is an isolated view of a light source configured as a cathode ray tube; and

FIG. 16(d) is an isolated view of a light source configured as an array of fiber-optic cable ends.

### DETAILED DESCRIPTION OF THE INVENTION

For purposes of promoting an understanding of the principles of the invention, reference will now be made to the embodiments illustrated in the drawings and specific language will be used to describe the same. It will nevertheless be understood that no limitation of the scope of the invention is thereby intended, there being contemplated such alterations and modifications of the illustrated device, and such further applications of the principles of the invention as disclosed herein, as would normally occur to one skilled in the art to which the invention pertains.

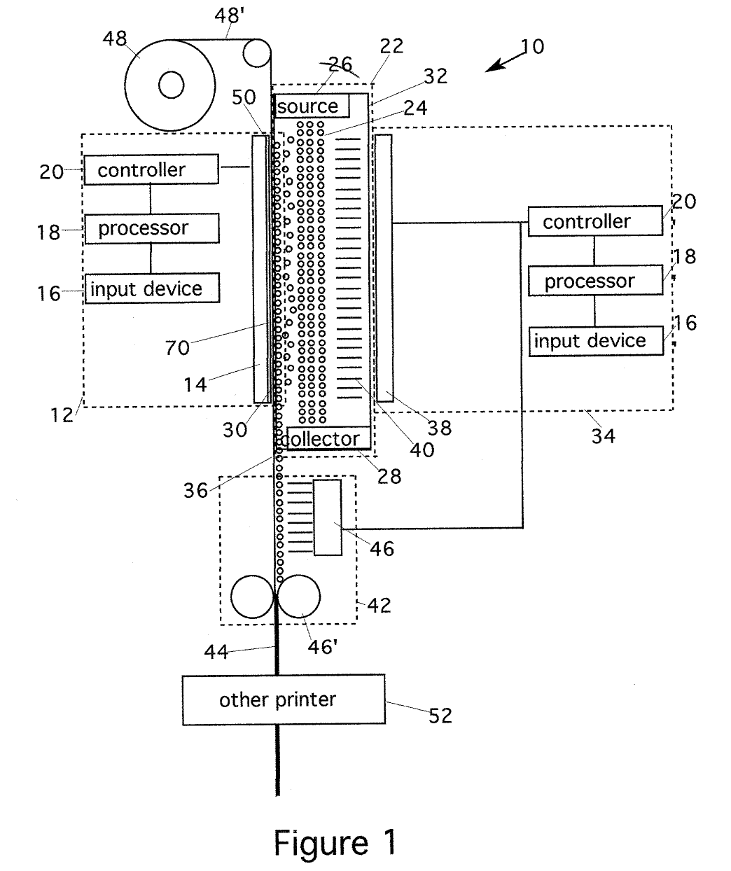

Referring to FIG. 1, an embodiment of the inventive printer 10 is shown. The inventive printer 10 is for forming an electronic circuit, such as a thin, bright, light and flexible display by the build up and curing of layers of electronically active microcapsules. The composition of the electronically active microcapsules will be discussed in detail below.

The inventive microcapsule printer 10 as shown in FIG. 1, includes image receiving means 12 for receiving an electronic circuit preform in a layer of electronically active microcapsules. The electronic circuit preform becomes an electronic circuit upon curing or otherwise developing the layer of microcapsules. The image receiving means 12 includes a locally variable attractive field plate 14. The electronic circuit preform may be in the form of a completed electronic circuit, including elements such as wiring lines, display pixels, discrete electronic components, etc. For example, the microcapsules selectively may include a conductive, insulative, semiconductive or resistive internal phase. By forming an electronic circuit of a number of discrete electrical components, each printed from microcapsules having the appropriate electrical characteristics, an electronic circuit, such as a thin, bright flexible display, can be constructed by the printing method described herein.

The image receiving means 12 also includes controlling means for controlling the locally variable attractive field plate 14 to selectively vary a respective local attractive field at corresponding discrete locations of the locally variable attractive field plate 14. In the embodiment shown in FIG. 1, the controlling means includes an input device 16, such as a computer, digitizer for digitizing the image of an electronic circuit or circuit components reflected from an original, or any other input devices which may supply input signals to a processor 18. The processor 18 processes the signals inputted from the input device 16 and generates a corresponding image receiving signal dependent thereon. This image receiving signal is received by a controller 20 which is effective to control the locally variable attractive field plate 14 by selectively varying a respective local attractive field at corresponding discrete locations of the locally variable attractive field plate 14.

In operation, a three-dimensional structure of the field attractive microcapsules 24 may then be constructed upon the electronic circuit forming microcapsule layer 30 so as to provide a three-dimensional structure having peaks and valleys as is shown and described in detail herein. Thus, in accordance with the present invention, a three-dimensional electronic circuit including specifically constructed three dimensional electronic circuit elements may be formed. Also, layers of circuitry may be constructed included through-holes and wiring lines for interconnecting the layers.

The inventive printer 10 further comprises microcapsule supplying means 22 for supplying a plurality of field attractive microcapsules 24 to be attracted to the discrete locations of the locally variable attractive field plate 14 depending on each locally attractive field. Thus, a layer of field attractive microcapsules 24 is formed having a thickness depending on the corresponding attractive field strength at each respective discrete location of the locally variable attractive field plate 14. This locally controllable thickness of microcapsules enables an effective manner for creating complex electronic circuits with electronic components have a wide range for electrical properties. As shown in FIG. 1, a microcapsule source 26 supplies a plurality of field attractive microcapsules 24 which, as shown in this embodiment, are allowed to cascade between the source and a collector 28. Some of these cascading field attractive microcapsules 24 are attracted to the locally variable attractive field plate 14 due to the attractive field present at the discrete locations of the locally variable attractive field plate 14. In accordance with the inventive printer 10, to form a uniform layer of field attractive microcapsules 24, the locally variable attractive field plate 14 has applied at every discrete location a uniform corresponding attractive field. Thus, a uniform layer 30 may be formed, which may be utilized to create a substrate having precisely control mechanical, electrical and chemical attributes.

In the embodiment shown in FIG. 1, the collector 28 comprises a controllably variable attractive field source which is effective for attracting at least some of those field attractive microcapsules 24 which are not sufficiently attracted to the locally variable attractive field plate 14 to be disposed as the electronic circuit forming microcapsule layer 30 or disposed so as to form a three-dimensional structure. Depending on the type of microcapsule used, the collector 28 may provide a magnetically attractive field or an electrostatically attractive field. Furthermore, shown in FIG. 1 as a solid-line rectangle, a screen 32 is provided enclosing at least the microcapsule source 26, the microcapsule collector 28 and the space therebetween. This screen 32 is effective to reduce the excessive loss of the cascading field attractive microcapsules 24. It is noted that this screen 32 may include means to provide a repulsive force to encourage the field attractive microcapsules 24 toward either the locally variable attractive field plate 14 or the collector 28, and may include a release coating, such as Teflon or the like, to prevent the field attractive microcapsules 24 from sticking on the screen 32. As compared with conventional electrostatically attracted microcapsules or printer toner, in accordance with the inventive use of magnetically attractive microcapsules, contamination due to paper dust or dirt will be less destructive to the re-use of the microcapsules collected in the collector, since paper dust and dirt are not magnetically attractive to the magnetically attractive field plate 14.

The inventive printer further comprises image forming means 34 for image-wise exposing the layer of electronically active microcapsules when necessary to form a latent electronic circuit image image 36 therein. For example, it may be advantageous to use a light curable microcapsule composition to enable the formation of precise electronic components. The local attractive field is effective for attracting a desired bulk of microcapsules to a particular location. The light curable composition of the microcapsules enables this bulk to be cured with precision to obtain the desired electrical characteristics of the fabricated electronic circuit element. In the embodiment shown in FIG. 1, the image forming means 34 includes an irradiation source 38 for providing image carrying radiation 40 to image-wise expose the layer of electronically active microcapsules. This image carrying radiation 40 preferably comprises different wavelengths of electromagnetic radiation, each one of which is effective to cause the selective formation of a particular electronic circuit component from a corresponding electronic circuit component forming microcapsule mixture. By such image-wise exposure, an electronic circuit may be produced through the selective releasing and mixing of the electronically active material having different electrical properties. For example, the resistance portion of resistors can be formed from microcapsules that contain a resistive material, such as carbon, while the conductive portion (leads) of the resistors can be formed from microcapsules that contain conductive material, such as a conductive polymer or metal.

In the embodiment shown in FIG. 1, the image forming means 34 includes electronic circuit forming controlling means (which may utilize one or more of the same components as the controlling means). An input device 16′, such as a computer, or any other device which may provide input signals corresponding to an electronic circuit is provided. The input signals are received by a processor 18′, such as a computer microprocessor, to determine electronic circuit forming signals dependent thereon. These electronic circuit forming signals are received by a controller 20′ to control the irradiation source 38 so as to selectively image-wise expose the layer of electronically active microcapsules and produce the latent electronic circuit image 36 therein. The irradiation source 38 may be a CRT, LCD, LED, laser, or other electronic circuit radiation source, including also a reflective type irradiation source in which light is reflected from an original and is focused so as to image-wise expose the layer of electronically active microcapsules. Also, a fiber-optic face plate CRT may be used to image-wise expose the layer of electronically active microcapsules. A fiber optic face plate is advantageous, for example, because the electronic circuit can be sharply focused when exposing the microcapsules. An example of a fiber-optic face plate is disclosed in U.S. Pat. No. 4,978,978, issued to Yamada.

The inventive microcapsule printer 10 further comprises image developing means 42 for developing the latent electronic circuit image 36 to form functioning electronic circuit 44. In an embodiment of the present invention, the image developing means 42 includes a heat source 46. This heat source 46 is effective to thermally rupture the electronically active microcapsules forming the latent electronic circuit image 36 so that the electronically active material in the microcapsules can be released and developed to form the functioning electronic circuit. Alternatively, the image developing means 42 may include pressure rollers 46′ to rupture the electronically active microcapsules by providing a rupturing pressure force. As will be discussed in detail below, the present inventive printer 10 may be used to form an electronic circuit having a three-dimensional structure, in which case it is preferable to use the heat source to rupture the microcapsule to form the functioning electronic circuit. It is contemplated that the developer may be present on the recording sheet in microcapsule form. Alternatively, the developer may be applied by spraying, dipping etc., or may be applied by other methods consistent with the prior art.

In the embodiment of the inventive printer shown in FIG. 1, recording sheet supplying means 48 is provided for supplying a recording sheet 48′ to the image receiving means 12. The recording sheet 48′ is for supporting the layer of electronically active microcapsules and the layer of locally attractive field microcapsules 24. Thus, a recording sheet 48′, which may be paper, synthetic paper, plastic or other suitable medium, is first disposed over an operable surface 50 of the locally variable attractive field plate 14. Then, the controlling means controls the locally variable attractive field plate 14. The controlling means includes varying means to selectively vary the respective local attractive field at corresponding discrete locations of the locally attractive field plate while the field attracted microcapsules are cascaded from the microcapsule source 26. Thus, the electronic circuit forming microcapsule layer 30 may be formed.

Alternatively, the electronic circuit forming microcapsule layer 30 may be provided on the recording sheet 48′ prior to the recording sheet 48′ being disposed adjacent to the locally variable attractive field plate 14. Then, an additional layer of field attractive microcapsules 24 may be provided over the electronic circuit forming microcapsule layer 30 at selected locations by varying the attractive field at the discrete locations of the locally variable attractive field plate 14. For example, the electronic circuit forming microcapsule layer may comprise a layer of developed microcapsules. A uniform (two-dimensional) or non-uniform (three-dimensional) layer of electronically active microcapsules may be formed over the layer, and than image-wise exposed to light to form a latent electronic circuit image. The encapsulated developer and the encapsulated exposed electronically active material are released, by pressure, heat, etc., and mixed together to obtain the developed functioning electronic circuit from the latent electronic circuit image.

Alternatively, the electronic circuit forming microcapsule layer 30 may be provided by applying a uniform attractive field, such as a uniform electrostatic field, to the surface of an electrostatic attracting means 70 disposed adjacent to the surface of the locally variable attractive field plate 14, and then additional microcapsules may be disposed at the discrete locations by varying the local attractive field. For example, a uniform electronic circuit forming microcapsule layer 30 may be provided through electrostatic attraction while an additional field attractive microcapsule layer 24 having a thickness, which may vary from location to location, may be provided through magnetic attraction at selectable discrete locations of the locally variable attractive field plate 14.

The inventive printer 10 may further comprise an additional printing means 52, such as another printer, which may be provided before or after the locally variable attractive field plate 14 to dispose on the recording sheet 48′ electronic circuits additional to those electronic circuits formed by the image receiving means 12 and the image forming means 34. This other printer may be, for example; a laser printer, another microcapsule type printer, an impact printer, a thermal printer, an inkjet printer, or any other suitable printer. Thus, a combination of types of printed electronic circuits may be provided on a single recording sheet 48′. For example, it is contemplated that a substrate and OLED portion of a light, bright flexible display may be printed on the recording sheet 48′ using an inkjet printer and then other circuit device, such as a battery portion including electrodes sandwiching an electrolyte, may be printed on the same recording sheet 48′ using the image receiving means 12 and the image forming means 34 described herein.

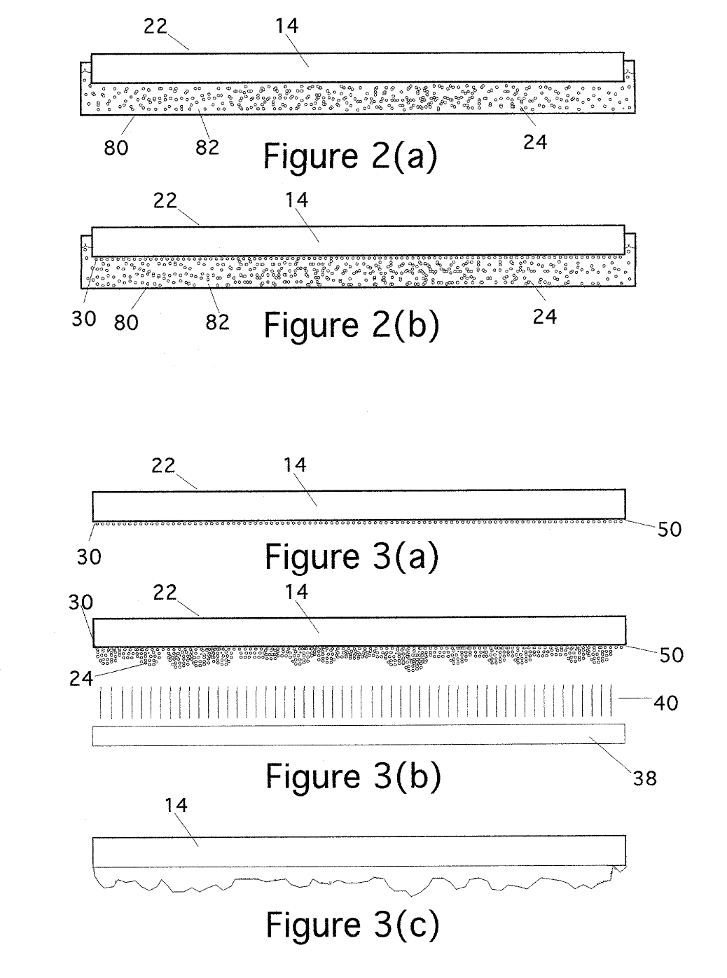

Referring now to FIGS. 2(a) and 2(b), an alternative embodiment of the microcapsule supplying means 22 is shown. In this embodiment, the microcapsule supplying means 22 includes microcapsule containing means 80 for containing the plurality of field attractive microcapsules 24 at a position which is adjacent to the locally variable attractive field plate 14 so that at least some of the plurality of field attractive microcapsules 24 can be attracted to the discrete locations of the locally variable attractive field plate 14 so as to form the layer of field attractive microcapsules 24. The field attractive microcapsules 24 may be in a dry form wherein the microcapsules are not dispersed in a dispersing liquid 82 or, as shown, in a wet form wherein the microcapsules are dispersed in a dispersing liquid 82. Furthermore, the dispersing liquid 82 may be agitated such as by a fluid pump (not shown) to maintain an even statistical distribution of the microcapsules dispersed therein.

As shown in FIG. 2(b), upon the application of a uniform attractive field (such as a uniform magnetic field or a uniform electrostatic field) an electronic circuit forming microcapsule layer 30 is formed on the operable surface 50 of the locally variable attractive field plate 14. Upon application of a non-uniform attractive field, a microcapsule layer (which may be include electronically active microcapsules for electronic circuit formation) is built up of the locally attracted attractive field microcapsules 24.

Referring to FIGS. 3(a) through 3(c), a schematic representation of one of the ways contemplated of forming an electronic circuit having a three-dimensional structure is shown. It is noted, that in accordance with the present invention a number of other ways of effecting the desired result may be utilized, some of which are described herein. However, it is further noted that the ways of obtaining the desired electronic circuit utilizing the present invention shown in these drawings and described herein are illustrative of the various components of alternative combinations contemplated within the scope of the present invention.

FIG. 3(a) shows a side view of the locally variable attractive field plate 14 on which a flat microcapsule layer 30 has been formed. This flat microcapsule layer may be formed over a recording sheet 48′ (as shown in FIG. 1) or may be formed directly onto the operable surface 50 of the locally variable attractive field plate 14 and serves as the substrate onto which the electronic circuit is formed. In this case, upon curing, and if an appropriate microcapsule composition is chosen, a self supportive structure may be formed of the cured and developed microcapsules which may alternatively be transferred to a supporting sheet or simply left as supporting on its own. This flat microcapsule layer 30 may be formed either by applying a uniform electrostatic field or a uniform magnetic field to attract the microcapsules and may not be necessary depending on the application.

As shown in FIG. 3(b), a build-up of a three-dimensional structure of electronic circuit forming microcapsules includes the peaks and valleys which create, for example, wire leads, antennas, RF receiving components, RF transmitting components, optically reactive and active circuit elements, resistors, capacitors, inductors, and semiconductor devices such as transistors, etc. FIG. 3(b) further shows the irradiation source 38 irradiating the three-dimensional structure of electronic circuit forming microcapsules with image carrying radiation 40 to selectively expose the microcapsules according to the image-wise exposure of the image carrying radiation. FIG. 3(c) shows the three-dimensional structure of the electronic circuit forming microcapsules after being developed and cured. The electronic circuits formed may include capacitors, resistors, wiring lines, coils, multiple layer batteries, and any other circuit element that may be fabricated using microencapsulated material applied in accordance with the present invention.

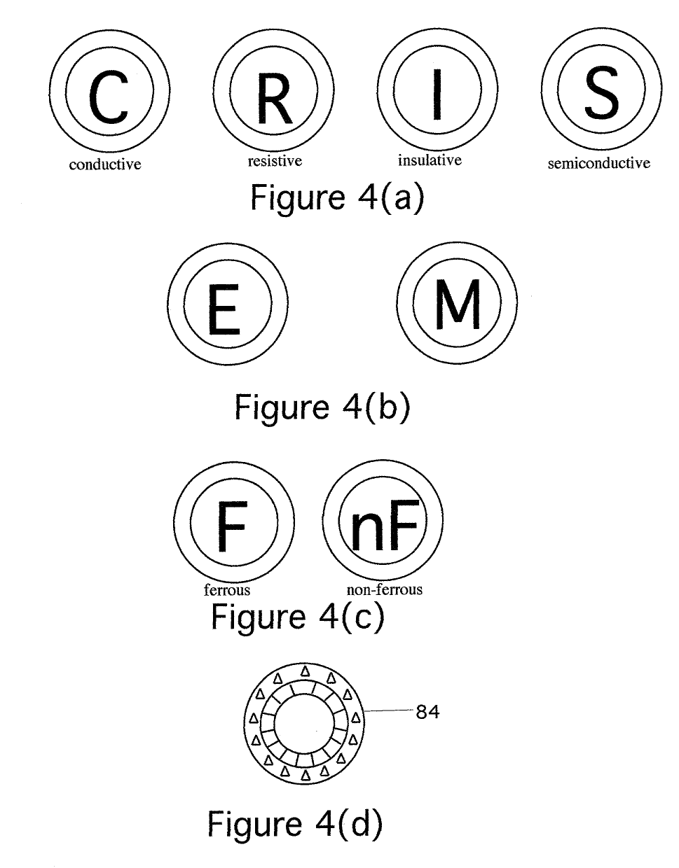

Referring to FIGS. 4(a) through 4(d), various compositions of the microcapsules utilized in the present invention are shown. It is noted that these specific compositions are illustrative only and are not meant to limit the possible composition of the microcapsules. In accordance with an embodiment of the present invention, several types of microcapsules are provided which contain a composition which may utilized to form an electronic circuit component. Depending on the composition of the microcapsules internal phase or shell, they are electrostatically and/or magnetically field attractive. Thus, these microcapsules may be used in the inventive printer for forming electronic circuits using the inventive printing method.

For example, the internal phase of the microcapsule may contain conductive materials, such as a metal or conductive polymer, resistive material, such as carbon, insulative materials, such as non-conductive polymers, and/or semiconductive materials. The microcapsules can contain material having just one such electrical property, or they may contain mixtures of materials or a single material that has a combination of electrical properties. Further, the shell of the microcapsule may also contribute its own electrical or mechanical characteristics to the ultimately formed electrical circuit. For example, the shell of the microcapsule may be comprised of a hard or hardenable substance that contributes a desired supporting strength to the printed object made in accordance with the present invention. As compared to electrically active microcapsules that are utilized in inkjet printing of an electronic device, the microcapsules and the printing method and apparatus of the present invention provide a more effective means for creating functioning electronic circuits. In accordance with the present invention, as described in detail herein, an number of electrical components can be quickly built-up out of field attractive microcapsules that are selectively attracted in a desired three dimensional shape. In the inkjet printing method of forming an electrical component, successive passes and spraying of the ink is done to slowly build up a desired thickness of electrically reactive material. This process is slow compared with the present invention where an increase in the local attractive field strength at desired locations may result in a relatively large number of microcapsules being attracted to build up the required three dimensional structure and thus form the functional components of a working electronic circuit using the inventive printing method.

The composition of such microcapsules may include a material which is electrostatically attractive, so that electrostatic attractive components of an embodiment of the inventive printer may be utilized. The shell of the microcapsule may be a heat meltable substance which forms at least a semi-rigid, strong integral structure upon curing of the functioning electronic circuit.

In FIG. 4(b), a composition of the battery or capacitor forming microcapsules is shown. A battery is generally comprised of an anode section and a cathode section between which is sandwiched an electrolyte. In accordance with the present invention, a electrical energy storage device may be fabricated using the inventive field attractive microcapsule printing method. In this case, the microcapsule may be composed of a microcapsule wall and an internal phase. The microcapsule wall may have a composition which includes a metal composition M, or the internal phase may include a composition which has a metal composition M (or both the wall and the internal phase may include compositions which include metals, such as Nickel, Lithium, Lead, etc.). An electrolyte is encapsulated in a polymer shell (which may be a conductive polymer) as represented by microcapsule E. By encapsulating the electrolyte as the internal phase within a field attractive microcapsule, the inventive printing method may be employed to readily form an electrolyte layer having a desired thickness.

In accordance with the present invention, a thin, lightweight, bright display, including a flexible battery, required capacitors, resistors, antennas, inductors, winding, coils, electrical lead lines, full color OLED-based display components, and all other components are all formable using the inventive field attractive microcapsule printing method.

For example, a flexible substrate is provided as a durable, insulative and protective base upon which the various battery, input, display and electrical circuit layers or formed. The flexible substrate may be, for example, a plastic sheet comprised of nylon, polyethylene, or other suitable material. A flexible battery is formed upon the flexible substrate. The large surface area of the flexible substrate allows a battery to be formed which has adequate energy storing capacity and is very thin. The inventive battery is obtained by forming layers of microencapsulated electrically active materials which make up the components of the functioning battery. A cathode section is formed by forming a first cathode microcapsule layer. The encapsulated cathode material (represented by microcapsule M in FIG. 4(b)) may be comprised of a high-purity manganese dioxide (MnO.sub.2) internal phase M contained within a polymer shell. A first battery lead is formed by printing an electrode sheet using the inventive printing method. The first battery lead (the electrode sheet) is formed over the first cathode microcapsule layer and a second cathode microcapsule layer is formed on top of this battery lead. An anode section is formed by forming a first anode microcapsule layer. The encapsulated anode material may be comprised a lithium-containing material internal phase contained within a polymer shell. A second battery lead is formed (again, a sheet electrode is formed using an electrically conductive encapsulated material and the inventive printing method) adjacent to the first anode microcapsule layer. A second anode microcapsule layer is formed on top of this battery lead. Between the anode section and cathode section is an electrolytelayer. The electrolyte layer may be a highly conductive electrolyte in a polymer matrix. The electrolyte layer may be formed by microencapsulating a liquid electrolyte internal phase within a field attractive microcapsule shell (microcapsule E).

As shown in FIG. 4(c), other field attractive microcapsule formulas may be used to create other electronic circuit components. For example, the inventive magnetic grid may include a ferrous core disposed within the printed winding (in fact, the winding may be formed as a three dimensional spiral around a ferrous core. A microcapsule F containing a ferrous material, such as iron, may be utilized to form the ferrous core using the inventive printing method. Also, non-ferrous material (microcapsule nF), such as aluminum, may be microencapsulated and printed using the inventive printer and printing method to produce electronic components that are not, or that are quasi-, magnetically reactive.

FIG. 4(d) shows a heat meltable microcapsule 84, in which infra-red rays having different wavelengths may be image-wise radiated to expose the microcapsule so as to cause selective curing and to allow rupturing of the microcapsule using heat instead of pressure. Such a microcapsule composition is disclosed in U.S. Pat. No. 4,916,042. Further, it is noted that other compositions of microcapsules which may be heat meltable for rupturing are contemplated by this invention. For example, the microcapsule wall may be composed of a material which melts uniformly upon the application of heat at a specific temperature. Thus, the developing means 42 may include a heat source 46 which provides such a temperature to thereby rupture the microcapsules and produce the functioning electronic circuit from the latent electronic circuit image without requiring the application of pressure. A developer (which may be required as a catalyst to form some electronic circuit materials from microencapsulated precursor materials) may be included in microcapsule form and ruptured along with the electronically active microcapsules. Also, a light source, such as a laser, may be provided for applying electromagnetic radiation at specific wavelengths effective to be absorbed by the heat meltable microcapsule 84 to generate heat.

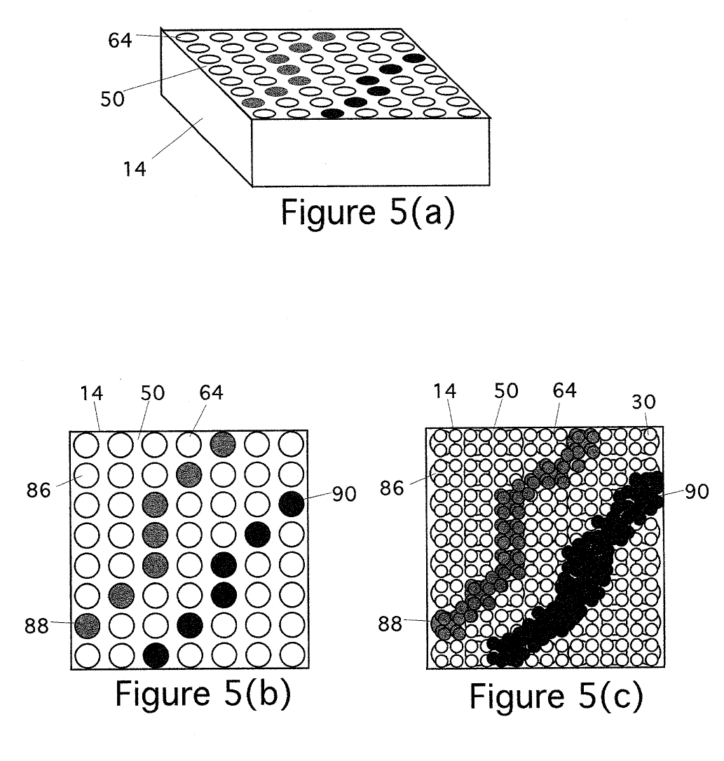

Referring now to FIGS. 5(a) through 5(c), a portion of the locally variable attractive field plate 14 is shown in which each magnetically variable pixel is comprised of the top surface of the core 64 of each individually controllable electromagnetic source 62. It is pointed out that this construction is for illustration only and that it is also representative of the electrostatically variable pixel and individually controllable electrostatic source (in which case the construction would not include an iron core, but would provide a plurality of individually controllable attractive field sources). As shown in FIGS. 5(a) through 5(c), the locally variable attractive field plate 14 has an operable surface 50 which includes a plurality of individually controllable attractive field sources, each in operable connection with a corresponding discrete location of the operable surface 50. In the embodiment shown in FIGS. 5(a) through 5(c), the top of the cores of individually controllable electromagnetic sources 62 act as magnetically variable pixels.

These magnetically variable pixels are equally spaced and the individually controllable electromagnetic sources 62 may be encased in a magnetically insulating material so that the influence of each individual magnetic pixel is limited to a magnetic end effect influence on its neighboring magnetic pixels. As shown more clearly in FIG. 5(b), some of the magnetically variable pixels have a uniform or no magnetic field 86. Others of the magnetically variable pixels have a relatively weak additional magnetic field 88, while still others of the magnetically variable pixels have a relatively strong additional magnetic field 90. It is noted that each of the magnetic pixels may be controlled so as to have a magnetic field strength which may be applied at a strength being anywhere from a maximum positive magnetic field, when a maximum current of one polarity is applied to the individually controllable electromagnetic source 62, to a zero magnetic field when no current is applied to the individually controllable electromagnetic source 62, to a maximum negative magnetic field when a maximum opposite polarity current is applied to the individually controllable electromagnetic source 62. In conventional terminology, the magnetic field may be described as north polar or south polar.

As shown in FIG. 5(c), when a uniform magnetic field is applied to the magnetically variable pixels, a uniform electronic circuit forming microcapsule layer 30 is formed. Alternatively, as discussed with regards to other Figures, this uniform electronic circuit forming microcapsule layer 30 may be formed by electrostatic attraction. The pixels having a relatively weak additional magnetic field 88 form a buildup of a three-dimensional structure of microcapsules which are attracted to the relatively weak magnetic field. This three-dimensional buildup of microcapsules enables the effective formation of various electronic circuit components. The electrical properties of the formed electronic circuit components will depend on the composition of the attracted microcapsules and the three-dimensional structure. The pixels which have a relatively strong additional magnetic field 90 have a buildup of a three-dimensional structure of microcapsules which are attracted to the relatively strong magnetic field. In accordance with the present invention, the number of microcapsules built up, and thus the ultimate dimensions of the three-dimensional structure formed by the microcapsule buildup is dependent on the strength of the applied magnetic field applied through each of the magnetically variable pixels. Also, alternatively, the same structure may be provided by utilizing electrostatically variable pixels or, in the manner well know, using a laser printer engine to create an electrostatically attractive variation on the surface of a rotating drum or a plate. In accordance with the present invention, a laser printer engine would be usable for printing electronic circuit elements by providing a toner composition wherein the contents of the toner includes the proper electrically active components. In this case, a number of toner sources can be selected and attracted to the electrostatically attractive plate or drum, with each source having the appropriate toner composition for the desired formation of an electronic circuit element.

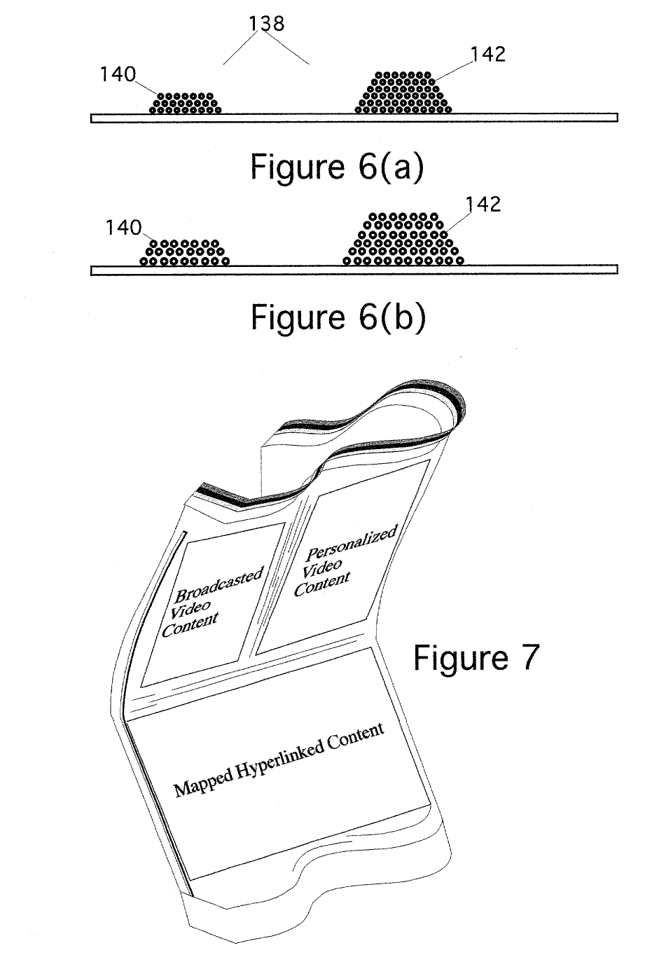

Referring to FIGS. 6(a) and 6(b), a method of forming an electronic circuit element having a three-dimensional structure in accordance with the present invention is illustrated. A structure of microcapsules 138 is built up on the locally variable attractive field plate 14 so as to form structures having, for example, a three-dimensional structure 140 of microcapsules attracted to individually variable pixels having a relatively weak additional magnetic field, and a three-dimensional structure 142 of microcapsules attracted to individually variable pixels having a relatively strong magnetic field. In this embodiment, the microcapsules are thermal expansive and may be thermally expanded through the application of heat. The thermal expansion of the microcapsules may effect curing, and decrease the density of the encapsulated electrically reactive material contained within the fabricated electronic device. This control of the device density may be advantageous to enable the formation of circuit elements, such as resistors, capacitors, etc., having desired electrical characteristics.

FIG. 7 illustrates the inventive thin, lightweight, flexible, bright, wireless display schematically showing the simultaneous display of three received display signal The inventive thin, lightweight, flexible, bright, wireless display includes a flexible substrate to provide a support structure upon which components can be manufactured by a printing method. As described in the co-owned, concurrently filed. US Patent Application entitled “A Thin, Lightweight, Flexible, Bright, Wireless Display”, the disclosure of which is incorporated by reference herein, a unique and effective method for transmitting display information to a single or multiple displays enables such displays to not have to have substantial onboard storage or processing power. In accordance with this aspect of the invention, the energy drain, bulk, weight and cost normally associated with such devices is avoided, and the durability and convenience of the display is increased. Further, as shown schematically in FIG. 7, multiple streams of display information can be simultaneously received and displayed. For example, broadcast video content such as a television program may be shown at a first portion of the display, personalized video content, such as a videophone conversation may be shown at a second portion and a web page, including mapped hyperlink content, may be shown at a third portion. Most of the processing, networking, signal tuning, data storage, etc., etc., that it takes to create such a set of displayed content streams is not performed by the inventive wireless display. Other devices, such as a centralized computer, A/V or gateway device perform these functions thus allowing the opportunity for the inventive display to have tremendous mobility and convenience.

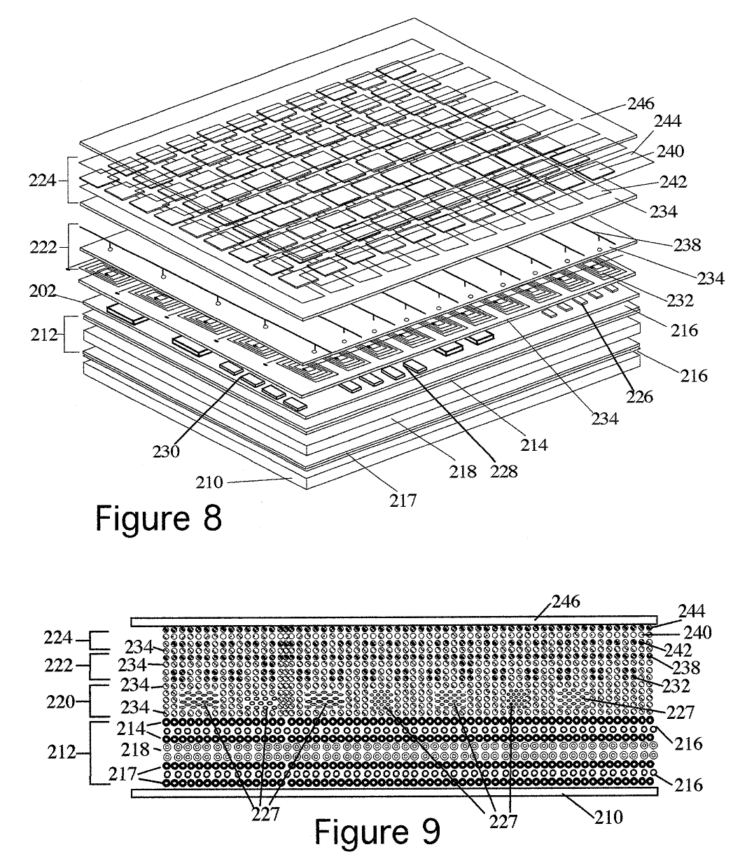

FIG. 8 illustrates some of the layers forming the inventive thin, lightweight, flexible, bright, wireless display. A flexible substrate 210 provides a durable, inslulative and protective base upon which the various battery, input, display and electrical circuit layers or formed. The flexible substrate 210 may be, for example, a plastic sheet comprised of nylon, polyethylene, or other suitable material. A flexible battery 212 is formed upon the flexible substrate 210. The large surface area of the flexible substrate 210 allows a battery to be formed which has adequate energy storing capacity and is very thin. As described herein, the flexible battery 212 may be formed using the inventive microcapsule printing method, or a flexible substrate and battery support sheet may be formed by laminating the various component sheets together to form the support sheet upon which the display and electronic circuit is formed. In general, the flexible battery in accordance with the present invention comprises a cathode layer 214, which may be formed of a cathode film. The cathode layer 214 may be comprised of a high-purity manganese dioxide (MnO.sub.2) material. A current collector 216 formed of a metal foil or screen or mesh or equivalent is provided adjacent to the cathode layer 214. This current collector 216 forms the positive lead of the battery. An anode layer 217 is comprised of an anode film having a current collector 216 disposed adjacent to it. The anode layer 217 may be comprised of a lithium-containing material. A current collector 216 forms the negative lead of battery. Between the anode layer 217 and cathode layer 214 is an electrolytelayer. The electrolyte layer 218 may be a microcapsule comprised of a highly conductive electrolyte in a polymer matrix. The electrolyte layer 218 may be formed by impregnating a polymer with a liquid electrolye, or using the inventive printing method, by microencapsulating a liquid electrolyte internal phase within a field attractive microcapsule shell.

FIG. 8 is a schematic representation of the stratum of the inventive thin, lightweight, flexible, bright, wireless display. The inventive display is inexpensive to manufacture, yet robust and highly effective. A flexible substrate 210 provides a structure on which to form the various stratum that make up the display, and allows for a display with high degree of flexibility and durability. The flexible substrate 210 may be, for example, plastic, paper or coated paper, or other suitable material.

A battery stratum 212 provides electrical energy to the electronic circuit stratum 220, user input stratum 222 and display stratum 224 components. The battery stratum 212 may comprise a first current collector 216 layer printed on a flexible inslulative substrate which may be the flexible substrate 210. One of an anode layer 217 or a cathode layer 214 is printed on the first current collector 216 layer. A microencapsulated electrolyte layer 218 is printed on the anode layer 217 or the cathode layer 214. The other one of the anode layer 217 or the cathode layer 214 is printed on the electrolyte layer 218 and a second current collector 216 layer printed on this anode layer 217 or the cathode layer 214. The dimensions of the battery stratum 212 can be substantially the entire surface area of the wireless display. Thus, a very efficient and thin battery can be formed. Since the battery will create a signal shielding effect, it may be desirable to use less than the total surface area available for forming the battery, and locate an antenna such that it can receive signals from most directions. Alternatively, it may be advantageous to utilize the shielding and signal reflection capabilities to create directionality of the received and/or transmitted signals. Further, the battery stratum 212 may be comprised of multiple layers to increase the storage density and tailor the electrical characteristics of the battery.

The inventive wireless display also includes an electronic circuit stratum 220. The components of the electronic circuit stratum 220 may be formed using a printing method or may be formed using other techniques such as surface mount circuit assembly or a combination depending on the electronic components and the circuit design. The electronic circuit stratum 220 includes signal transmitting components 226 for transmitting user input signals. These user input signals are used to control remote devices such as computers, A/V equipment, videophone devices, appliances, household lighting, etc. The user input signals may be transmitted directly to the device being controlled, or, as described herein, may be received by a central device, such as a computer, and then the computer used for controlling the device.

An important aspect of the present invention is the ability to provide a thin, lightweight, bright, wireless display device that is low cost and easy to manufacture. Typically, a mobile display device, such as a laptop computer or webpad, requires substantial on-board processing power to receive, for example, a wireless modem signal connected to the Internet and to display webpages. It is an object of the present invention to completely avoid the need for such processing power at the display, thereby reducing cost, size, battery consumption and increase durability and effectiveness. Therefore, in accordance with the present invention, signal receiving components 228 are included in the electronic circuit stratum 220 for receiving display information, and display driving components 230 are included for driving the display layer according to the received display information. As described herein, the signal receiving components 228 consist of devices such as RF antenna and receiver circuit, much or all of which can be formed by creating a circuit of electronic components formed the inventive microcapsule printing method.

The inventive thin, lightweight, bright, wireless display also includes a user input stratum 222 for receiving user input and generating the user input signals. The user input stratum 222 may be a grid of conductive coils 232 that can be formed by a printing method by printing a conductive material, such as a conductive polymer.

The conductive coils 232 are effective for generating an electrical current when a magnetic field passes over the coil. A detection circuit (not shown) detects the location of the induced electrical current (as in a conventional touch screen input device) and thus locates the user input.

The user input stratum 222 may comprise a grid of conductive elements printed on an insulative layer 234. The conductive elements are for inducing a detectable electrical signal in response to a moving magnetic field. The moving magnetic field is created by, for example, passing a magnetic pen tip over the surface of the inventive wireless display. The location of the conductive elements having the induced magnetic field enables the user input to be mapped. This mapped input can be transmitted to a central computer device (as described herein) to enable hyperlink access of Internet based content, hand writing recognition, drawings, highlighting text, etc

Referring again to FIG. 8, a display stratum 224 comprising light emitting pixels 240 for displaying information is supported by the substrate. The display stratum 224 is preferably fabricated along the lines taught in co-owned US patent application entitled “A Thin, Lightweight, Flexible, Bright, Wireless Display”, filed concurrently herewith, the disclosure of which is incorprated by reference. The display stratum 224 may be formed over other layers of the inventive wireless display. These other layers may be formed by a printing manufacturing method, or they may be formed by other means. For example, all or parts of the battery stratum 212 described herein may be formed by laminating sheets of appropriate materials such as anode, cathode, charge collectors and electrolyte layers.

The light emitting pixels 240 of the display stratum 224 may be formed by providing an insulative layer 234, such as a sheet of polymer sheet material laminated or printed on a layer of the inventive display. An x or y-electrodes layer 242 comprising lines of a conductive material is formed over the insulative layer, preferably by printing the conductive polymer onto the insulative layer 234. A pixel layer of light-emitting conductive polymer islands 240 is printed over the y-electrode layer 242. A y or x-electrodes layer 244 comprising lines of a transparent conductive material is formed over the pixel layer.

The display stratum 224 may include printed conductive leads connected with each light emitting pixel for applying the electrical energy selectively to each light emitting pixel under the control of the display driving components. The signal receiving components 228 may include first radio frequency receiving components for receiving a first display signal having first display information carried on a first radio frequency and second radio frequency receiving components for receiving a second display signal having second display information carried on a second radio frequency. The display driving components 230 may also include signal processor components, such as a DSP, for receiving the first display signal and the second display signal and generating a display driving signal for simultaneously displaying the first display information at a first location on the display stratum 224 and the second display information at a second location on the display stratum 224. Using this construction, a display signal may be received from, for example, a computer located in one room in a house, and a second display signal received from, for example, a television set top box located in another room in the house. The information carried in the two display signals can be simultaneously displayed, enabling, for example, web browsing and TV viewing at the same time on the inventive wireless display. Further, the inventive wireless display may be constructed so that three or more such signals may be received and displayed simultaneously.

The display stratum 224 may be formed so that three layers of pixel elements are formed one on top of the other. Each layer being comprised of OLED pixels 240 that generate a colored light (as in the pixels 240 of a conventional color television). A full color display is obtained by controlling the on-off state and/or light intensity of each pixel 240. A transparent protective substrate 246 may be provided over the display stratum 224, the protective substrate 246 may be, for example, a clear, durable, flexible polymer.

In accordance with the present invention, at least some of the components in the electronic circuit stratum 220 are formed by printing electrically active material to form circuit elements including resistors, capacitors, inductors, antennas, conductors and semiconductor devices. This allows for a very adaptable, efficient and effective manufacturing process, and enables the inventive device to be realized at a low cost.

FIG. 9 is a representation of an embodiment of the inventive thin, flexible, lightweight, bright, wireless display manufactured using a microcapsule printer. The drawing illustrates the buildup of microcapsule layers represented by round microcapsule elements. Of course, in practice, these layers will be developed and the microcapsules ruptured, In the case of laser toner, the microcapsules will be melted and ruptured. In the case of a microcapsule printer, the microcapsules will most likely be ruptured by pressure rollers or heat. Alternatively, some microcapsules may not require any development, but rather have a composition such that the unruptured or undeveloped microcapsule becomes a portion of a fabricated electronic element.

In accordance with the present invention, a thin, lightweight, flexible, bright, wireless display is obtained having components capable of being manufactured by a printing method. A flexible substrate 210 provides a support structure upon which components can be manufactured by a printing method. A display stratum 224 comprising light emitting pixels is provided for displaying information. The light emitting pixels are formed by printing a pixel layer 240 of light-emitting conductive polymer. The display stratum 224 includes printed conductive leads 242,244 associated with each light emitting pixel for applying the electrical energy selectively to each light emitting pixel under the control of the display driving components, the light emitting pixels being formed by providing an insulative layer 234, printing a y-electrodes layer 242 comprising lines of a conductive material formed over the insulative layer 234, printing a pixel layer of light-emitting conductive polymer islands 240 over the y-electrode layer 242, and printing an x-electrodes layer 244 comprising lines of a transparent conductive material over the pixel layer 240.

An electronic circuit stratum 220 includes user input mapping components for receiving user input signals and determining a physical location on the display at which the user input signals are received. The user input mapping components generate mapped user input signals. For example, the components of an electrode signal detecting circuit, such as that used by a touch screen device, can be utilized for detecting and mapping the user input signals received in response to the movement of a magnetic pen tip over the input grid. Signal transmitting components transmit the mapped user input signals as wireless information signals from the inventive wireless display device. Signal receiving components receive display information. The signal receiving components may include first radio frequency receiving components for receiving a first display signal having first display information carried on a first radio frequency and second radio frequency receiving components for receiving a second display signal having second display information carried on a second radio frequency. The display driving components include signal processor components for receiving the first display signal and the second display signal and generating a display driving signal for simultaneously displaying the first display information at a first location on the display stratum 224 and the second display information at a second location on the display stratum 224.

The signal transmitting and signal receiving components include well known electronic circuit elements such as antennas, resistors, inductors, capacitors, and other RF circuit devices, represented by electronic components 227. At least some of these devices, as well as the components of the other stratum of the inventive wireless display, may be fabricated directly using the inventive printer and printing method. Display driving components drive the display layer according to the received display information. These display driving components consist of well-known circuitry, such as the driver circuit of a conventional LCD screen. However, a conventional LCD screen uses pixels comprised of a liquid crystal shutter to allow selective passage of backlighting. In accordance with the present invention, organic light emitting element are used as the picture elemetns. Since each pixel emits its own light when driven, there is no need for back lighting, and the overall circuit complexity, cost and weight is reduced as compared to the LCD technology.

A user input stratum 222 receives user input and generates the user input signals. The user input stratum 222 comprises a grid of conductive elements 232 printed on an insulative layer, said conductive elements 232 being for inducing a detectable electrical signal in response to a moving magnetic field

A battery stratum 212 provides electrical energy to the electronic circuit stratum 220, user input stratum 222 and display stratum 224 components. The battery stratum 212 comprises a first current collector layer 216 printed on a flexible insulative substrate which may be the flexible substrate 210. An anode layer 217 is printed on the first current collector layer. An electrolyte layer 218 is printed on the anode layer 217. A cathode layer 214 is printed on the electrolyte layer 218 and a second current collector layer 216 is printed on the cathode layer 214. In accordance with the present invention, many of the components in the inventive wireless display are formed by printing electrically active material to form circuit elements including resistors, capacitors, inductors, antennas, conductors and semiconductor devices.

Specifically, with regard to the battery stratum 212 the large surface area of the flexible substrate 210 allows a battery to be formed having adequate energy storing capacity and very thin. As described elsewhere herein, a flexible substrate and battery support sheet may be formed by laminating the various component sheets together to form the support sheet upon which the display and electronic circuit is formed. In accordance with this aspect of the present invention, the flexible battery is formed using the inventive field attractive microcapsule printing method. However, it is noted that other printing methods may also be used in accordance with the formation of the inventive flexible battery, such as inkjet printing. In the case of inkjet printing the microcapsules containing the constituent parts of the inventive battery are dispersed within a liquid and sprayed onto the flexible substrate 210 in the inkjet printing method. In accordance with the present invention, the battery is obtained by forming layers of microencapsulated electrically active materials which make up the components of the functioning battery. A cathode section is formed by forming a first cathode microcapsule layer. The encapsulated cathode material may be comprised of a high-purity manganese dioxide (MnO.sub.2) internal phase contained within a polymer shell. A first battery lead formed of a metal foil or screen or mesh or equivalent is provided adjacent to the first cathode microcapsule layer. A second cathode microcapsule layer is formed on top of this battery lead. An anode section is formed by forming a first anode microcapsule layer. The encapsulated anode material may be comprised a lithium-containing material internal phase contained within a polymer shell. A second battery lead is formed of a metal foil or screen or mesh or equivalent and is provided adjacent to the first anode microcapsule layer. A second anode microcapsule layer is formed on top of this battery lead. Between the anode section and cathode section is an electrolytelayer. The electrolyte layer may be a highly conductive electrolyte in a polymer matrix. The electrolyte layer may be formed by microencapsulating a liquid electrolyte internal phase within a field attractive microcapsule shell. Each microcapsule layer may be cured or ruptured during each layer forming step, or particularly in the case of pressure or heat rupturable microcapsules, the battery component microcapsule layers may be cured or ruptured all together after the formation of the top most layer. Using this method, a thin, flexible, lightweight power source is provided using the inventive microcapsule printing method. Similar to the structure described elsewhere herein, structural material-filled through-holes may be formed using field attractive microcapsules containing a suitable resin, polymer or other suitable substance to add strength and prevent delamination of the flexible battery component stack. Further, it may be desireable to form the battery so that the electrolyte be encapsulated in an electrically insulative outer shell, and is only active for generating electricity after being developed, such as by pressure rupture. Thus, a device, such as an RF tag or wireless display, may have a long shelf-life, with the device being activated for use by rupturing the electrolyte microcapsules.

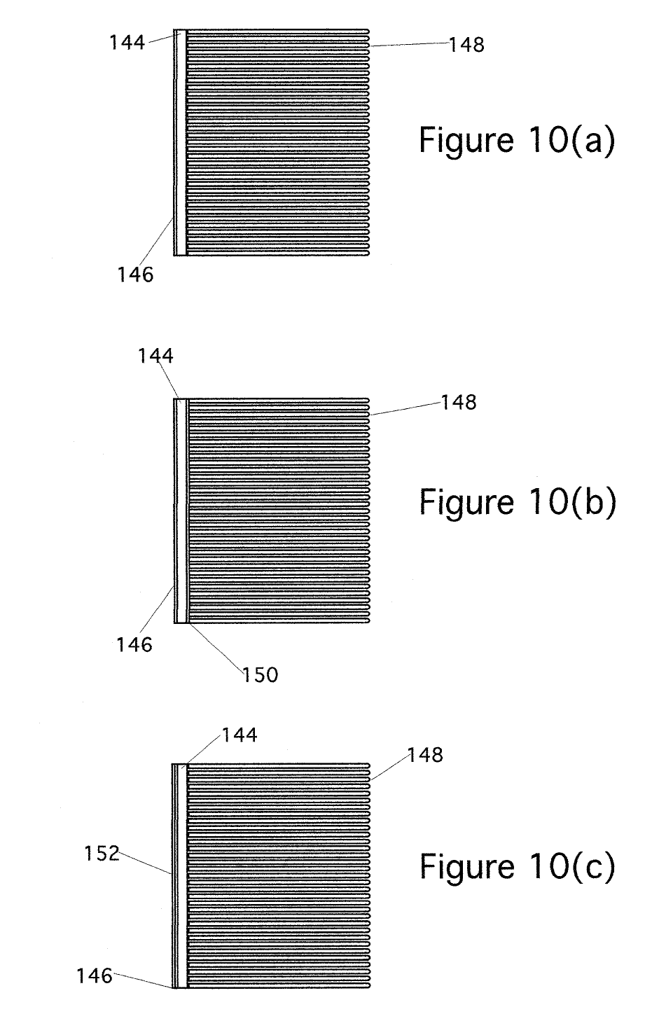

Another embodiment of the inventive printer for forming an electronic circuit in a layer of microcapsules will now be described. As shown in FIG. 10(a), image receiving means is provided for receiving an electronic circuit in a layer of field attractive microcapsules 24. The image receiving means comprises a locally variable attractive field member, which includes a glass plate substrate 144 having an optomagnetic coating 146 disposed thereon. An information light source comprises, for example, a bundle of fiber optic cables 148 are used to carry light information, and each form an individual fiber optic pixel. The ends of the individual fibers can be fused together to create the glass plate substrate, or to create a structure which is supported by the glass plate substrate 144. Furthermore, the optomagnetic coating 146 may alternatively be an optoelectric coating 146 which generates a uniform or varied electrostatic attractive field to attract electrostatic attractive microcapsules 24. By varying the spatial relation and the intensity of light information directed through the fiber optic cable bundle, the optomagnetic or optoelectric coating 146 becomes attractive so that it is able to attract field attractive microcapsules 24 on selected portions of the attractive field member. In accordance with the present invention, controlling means is operationally connected with the information light source for controlling the locally variable attractive field member to selectively apply an attractive field at locations of the locally variable attractive field member so that a layer of field attractive microcapsules 24 can be formed by selectively applying a local attractive field member.

In the embodiments shown in FIGS. 10(a)-10(c), the controlling means includes the ends of the fiber optic bundle, and is effective to control the strength of attraction of the attractive field member by applying light information impinging on selected locations of the optomagnetic coating 146, so that an attractive field is applied at locations of the attractive field member. When excited by impinging light, the optomagnetic coating becomes magnetically attractive by which magnetically attractive microcapsules are disposed on the attractive field member.

As shown in FIGS. 10(a)-10(c), a light beam is directed through the length of the fiber optic cables to impinge on the optoelectric and/or optomagnetic coating 146 to generate a magnetic field and/or an electrostatic field, for applying a respective attractive field at corresponding discrete locations of the optoelectric and/or optomagnetic coating 146. Both an optomagnetic and an optoelectric coating 146 may be applied so that, for example, microcapsules 24 having different compositions can be selectively electrostatically and magnetically attracted to produce a number of effects.

The light information source may be a phosphor coating 150 which emits light in response to an impinging electron beam. The phosphor coating 150 can comprise a black and white phosphor screen to provide high contrast, and gray shading, to vary the optomagnetic and optoelectric effect. A color producing phosphor screen can be used to impart color information, which will have varying effects depending on the attributes of the optoelectric, optomagnetic coating 146.

In the embodiment shown in FIG. 10(c), a light shielding layer 152 can be used to prevent unwanted exposure of microcapsules 24 by light information used to control the strength of attraction of the attractive field member. As an alternative, the optomagnetic layer and electronically active material of the microcapsules 24 can be reactive to different wavelengths of light, to prevent premature exposure of the electronically active material.

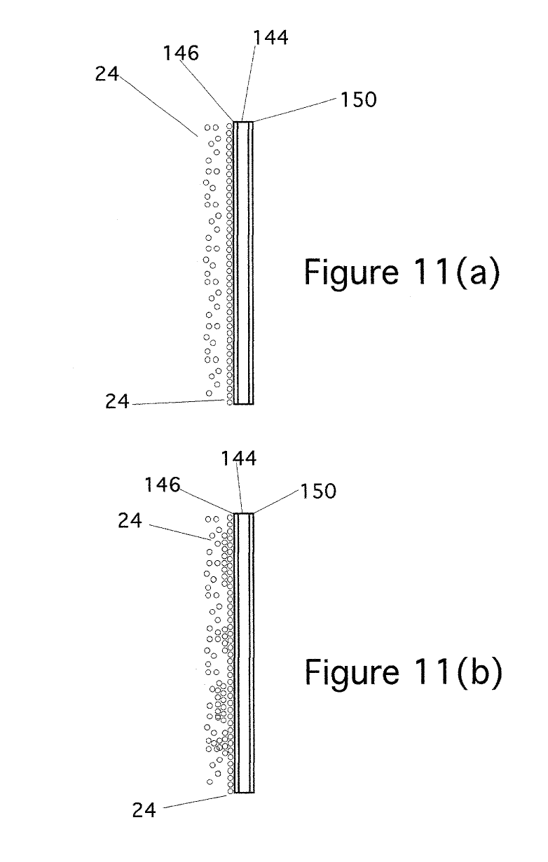

Referring now to FIG. 11(a), an even intensity and/or wavelength can be applied to impinge on the optomagnetic coating 146, so as to provide a uniform magnetic field resulting in a uniform layer of microcapsules 24 having a flat topography. Also, to produce various effects such as, disposing an electronic circuit at a discrete location on the recording sheet while leaving the rest of the recording sheet bare, forming a three-dimensional electronic circuit, or building-up a composite electronic circuit on a recording sheet by selectively forming electronic circuits at various discrete locations in a series of electronic circuit forming steps, a varied intensity and/or wavelength of light can be applied to impinge on the optomagnetic coating 146, so as to form a non-uniform magnetic field resulting in a non-uniform layer of microcapsules 24 having a varied topography

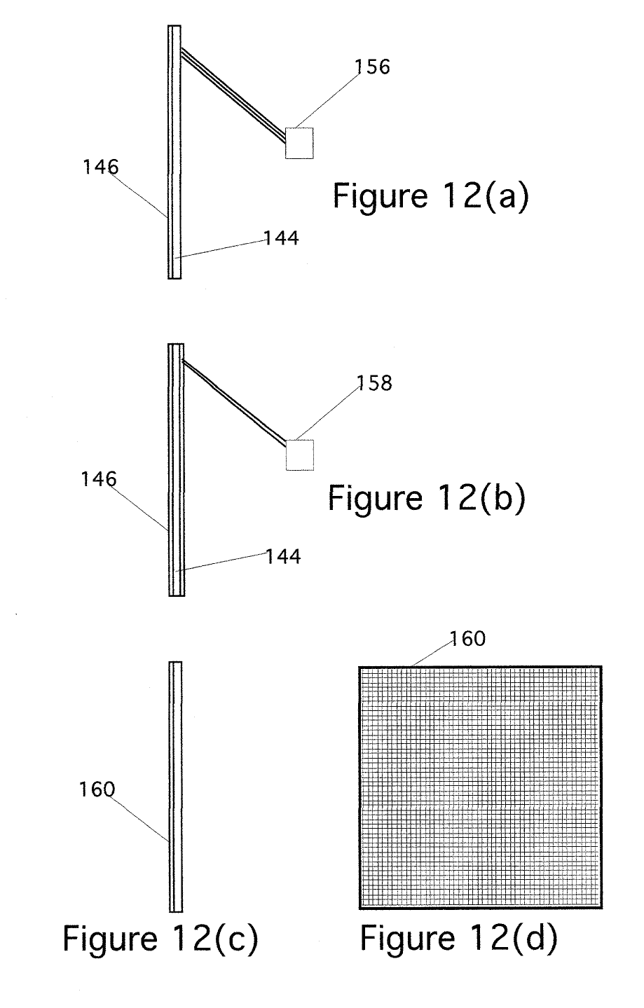

As shown in FIG. 12(a), a scanning laser from a laser source 156 can be used to write information in the optomagnetic coating 146 on the glass substrate 144. The scanning laser can be pulse modulated to selectively write information on the optomagnetic coating 146 at selected discrete locations. As shown in FIG. 12(b), a scanning electron gun 158 can be used to write information onto a phosphor coating 150. In this case, the scanning electron gun 158 can be scanned using conventional magnetic field manipulating techniques, such as that used for a conventional cathode ray tube. The phosphor screen thus produces an emission of light which impinges on the optomagnetic or optoelectric coating 146 and produces an optomagnetic and/or electrostatic effect at selected discrete locations of the attractive field member, so as to form a desired unexposed latent electronic circuit image forming layer of attractive microcapsules 24.

As shown in FIGS. 12(c) and 12(d), an LCD matrix 160, or matrix of light emitting diodes or diode lasers, can be used to write information to the optomagnetic and/or optoelectric coating 146. In the case of the LCD matrix 160, back lighting may be provided which is spatially modulated by the light valving effect of the LCD matrix 160. The LCD matrix 160 or the matrix of diode lasers (or LEDs) can be provided using the known techniques for forming such devices

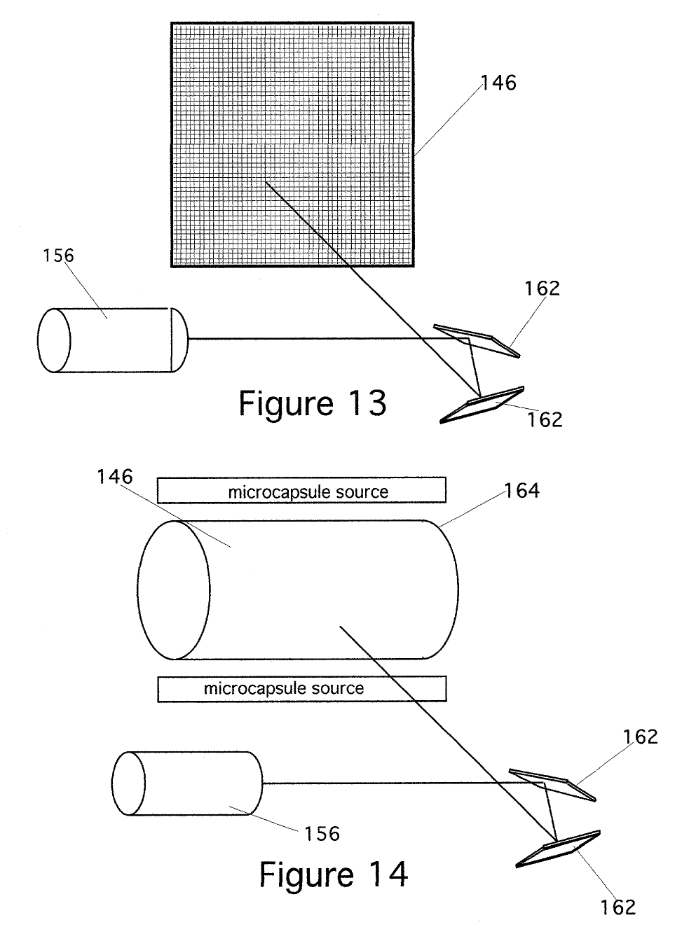

FIG. 13 shows an alternative embodiment in which a laser source 156 produces a laser beam which is scanned over a optomagnetic and/or optoelectric coating 146 on an attractive field member, using galvanoscanners 162. To improve the contrast, and to provide a separation of the discrete locations (i.e. pixels) on the attractive field member, the optomagnetic and/or optoelectric coating 146 may be formed into pixels. By etching the coating 146 into discrete pixels, the individually induced fields of each individual pixel will be more contained within the area of the separated pixels, so as to decrease the influence on neighboring pixels caused by the field induced in each individual pixel. Etching of the coating may be accomplished using known masking/selective etching techniques, such as those employed in printed circuit manufacture. The laser beam may be pulse modulated to carry spatial electronic circuit information. The galvanoscanners 162 are used to direct this pulse modulated laser beam to positions on the attractive field member to form a latent electronic circuit image. Thus, a locally varied attractive field may be produced by which attractive microcapsules 24 are formed into either a uniform layer having a flat structure, or a non-uniform layer having a varied structure. A latent electronic circuit image producing attractive field can be produced by controlling the scanning of the laser beam.

FIG. 14 shows an embodiment in which the attractive field member is configured as a rotating drum 164. The operational surface of the rotating drum 164 is coated with an optoelectric and/or optomagnetic coating 146, and one or more laser beams are scanned one line or more at a time across the surface of the rotating drum 164 so as to form an attractive field. In the case of multiple laser beams, the separate beams can be modulated to apply spatial light information. Also, one or more lines of fiber optic cables 148 can be used to direct light onto the rotating drum 164. Alternatively, an electron beam can be used to produce the varied attractive field.

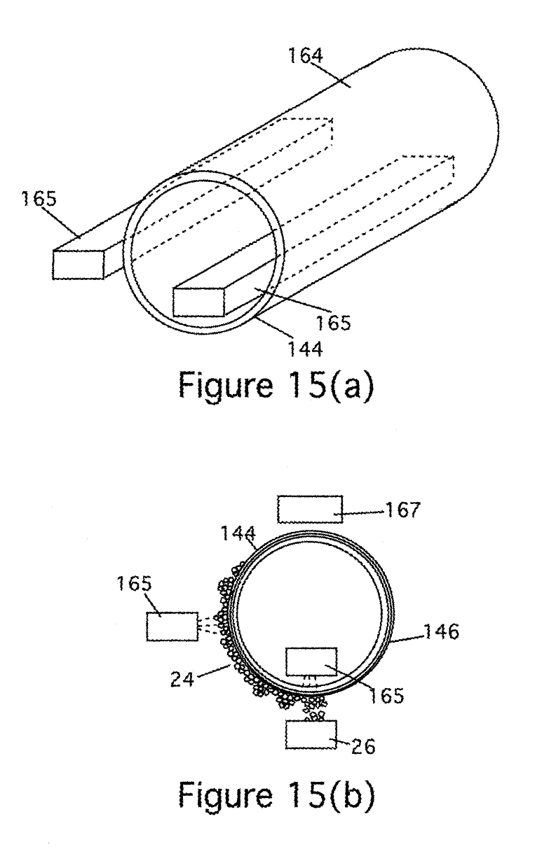

As shown in FIG. 15(a), the attractive field member configured as a rotating drum 164 may also be hollow and comprise, for example, a transparent substrate 144. An information carrying light source, such as one or more lines of fiber optic cables 148, a cathode ray tube, a matrix of liquid crystal light valves (or other spatial light modulator) a matrix of LEDs or diode lasers, or other information carrying lighting source, is disposed inside the hollow drum 164 at a position effective to radiate the optoelectric and/or optomagnetic coating 146 disposed on the hollow rotating drum 164. Light information passes through transparent drum 164 substrate 144 and causes the optoelectric and/or optomagnetic coating 146 to become locally variably attractive.

As shown in FIG. 15(b), light information from the information light source 165 disposed inside the hollow rotating drum 164 causes the optoelectric, optomagnetic coating 146 to produce an attractive field at the surface of the drum 164. Microcapsules 24 from a microcapsule source 26 are attracted to the surface of the rotating drum 164 (or to the surface of a recording sheet disposed on the rotating drum 164). As the drum 164 rotates, the layer of microcapsules 24 become disposed facing another information light source 165 (which may be configured as described with reference to the information light source disposed inside the drum 164). This other information light source 165 image-wise exposes the microcapsule 24 layer to produce a latent electronic circuit image. The latent electronic circuit image is then developed (not shown). Also, an erasing device 167 may be used to reset the magnetic or electrostatic field of the optoelectric, optomagnetic coating 146.

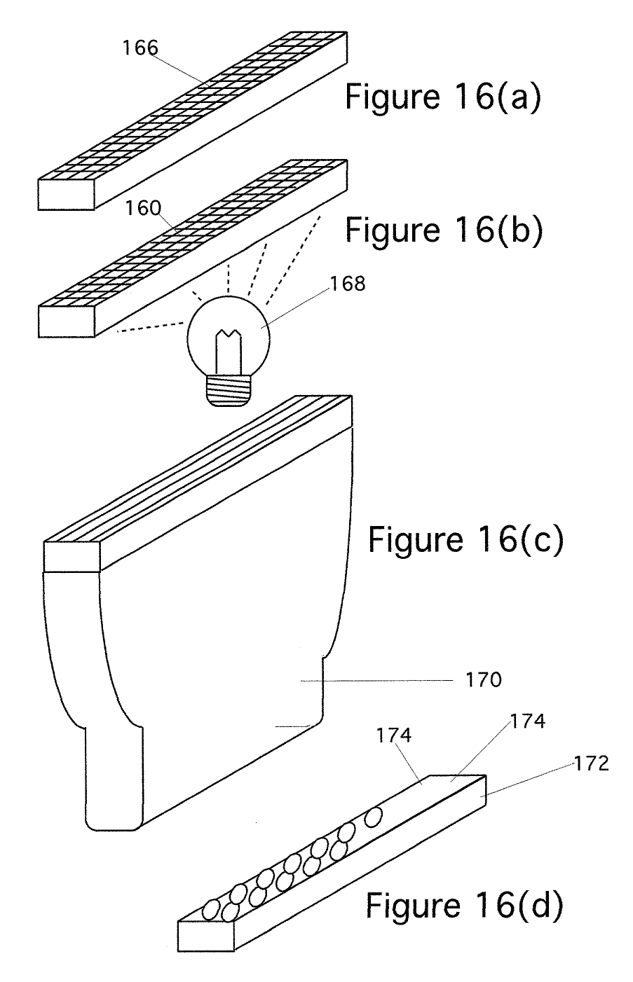

FIGS. 16(a)-16(d) show various configurations for the information light source. FIG. 16(a) shows the information light source configured as an LED or diode laser matrix 166; FIG. 16(b) shows the information light source configured as an liquid crystal light valve 160 having back lighting 168; FIG. 16(c) shows the information light source configured as a cathode ray tube 170; and FIG. 16(d) shows the information light source configured as an array of fiber-optic cable ends 172. The size of each element 174 of the array or matrix is exaggerated for illustration. The actual dimensions may vary depending on considerations such as costs, required resolution, space, etc.

1) A printer for forming an electronic device utilizing microencapsulated electrically active material, comprising: a locally variable attractive field member; controlling means for controlling the locally variable attractive field member to selectively apply an attractive field at locations of the locally variable attractive field member so that a layer of field attractive microcapsules can be formed, the field attractive microcapsules comprising an electrically reactive material whereby a predetermined electronic circuit component may be formed depending the composition and dimensions of the layer of field attractive microcapsules.

2) A printer for forming an electronic device according to claim 1; where the locally variable attractive field member further comprises at least one of an optoelectric and an optomagnetic coating formed on a substrate for generating an attractive field in response to light impinging on the at least one optoelectric and optomagnetic coating.

3) A printer for forming an electronic device according to claim 2; wherein the at least one optoelectric and optmagnetic coating is etched into pixels.

4) A printer for forming an electronic device according to claim 2; further comprising directing means for directing a light beam to impinge on the at lest one optoelectric and optomagnetic coating for gnerating at least one of a magnetic field and an electrostatic field in order to form a respective attractive field at corresponding discrete locations of the at least one optoelectric and optomagnetic coating.

5) A printer for forming an electronic device according to claim 4; wherein the directing means comprises a plurality of fiber optic light guides.

6) A printer for forming an electronic device according to claim 4; wherein the directing means further comprises a light beam source for generating a light beam and scanning means for scanning the light beam over the at least one optoelectric and optomagnetic coating for generating an attractive field in order to form a respective attractive field at corresponding discrete locations of the at least one optoelectric and optomagnetic coating.

7) A printer for forming an electronic device according to claim 2; wherein the locally variable attractive field member further comprises a light emitting coating on the substrate for generating light, the generated light impinging on at least one of the optoelectric and optomagnetic coating to generate at least one of an electrostatic and magnetic attractive field.

8) A printer for forming an electronic device according to claim 1; wherein the field attractive microcapsules are magnetically attractive; and the locally variable attractive field member further comprises magnetic field applying means for applying each local attractive field as a magnetically attractive field.

9) A printer for forming an electronic device according to claim 1; wherein the field attractive microcapsules are electrostatically attractive; and the locally variable attractive field member further comprises electrostatic field applying means for applying each local attractive field as an electrostatically attractive field.

10) A printer for forming an electronic device according to claim 1; whrein at least some of the field attractive microcapsules include at least one of a thermo-expansive and a heat meltable composition.

11) A method of forming a thin, lightweight display having components capable of being manufactured by a printing method, comprising: providing a support substrate for providing a support structure upon which components can be manufactured by a printing method; forming a display stratum comprising light emitting pixels for displaying information, the light emitting pixels being formed by printing a pixel pattern of light-emitting conductive polymer microcapsules; forming an electronic circuit stratum including electronic devices formed by printing patterns of electrically reactive microcapsules at discrete locations on the support substrate; forming a user input stratum for receiving user input and generating the user input signals, the user input stratum being formed by printing a grid of conductive elements, each conductive element being effective for generating a detectable electrical signal when a magnetic field passes the conductive element; and forming a battery stratum for providing electrical energy to the electronic circuit stratum, user input stratum and display stratum components.

12) A method of forming a thin, lightweight display according to claim 11; wherein the battery stratum comprises a first current collector layer; one of an anode layer and a cathode layer printed on the first current collector layer; an electrolyte layer printed on said one of the anode layer and the cathode layer; and an other one of the anode layer and the cathode layer printed on the electrolyte layer and a second current collector layer printed on said other one of the anode layer and the cathode layer.

13) A method of forming a thin, lightweight display according to claim 11; wherein the display stratum includes printed conductive leads connected with each light emitting pixel for applying the electrical energy selectively to each light emitting pixel under the control of the display driving components, the light emitting pixels being formed by providing an insulative layer, printing a y-electrodes layer comprising lines of a conductive material formed over the insulative layer, printing a pixel layer of light-emitting conductive polymer islands over the y-electrode layer, and printing an x-electrodes layer comprising lines of a transparent conductive material over the pixel layer.

14) A method of forming a thin, lightweight display according to claim 11; wherein the electronic circuit stratum includes signal receiving components including first radio frequency receiving components for receiving a first display signal having first display information carried on a first radio frequency and second radio frequency receiving components for receiving a second display signal having second display information carried on a second radio frequency, and display driving components including signal processor components for receiving the first display signal and the second display signal and generating a display driving signal for simultaneously displaying the first display information at a first location on the display stratum and the second display information at a second location on the display stratum.

15) A method of forming a thin, lightweight display according to claim 11; wherein at least some of the components in the battery, display, user input and electronic circuit stratum are formed by printing electrically active material to form circuit elements including resistors, capacitors, inductors, antennas, conductors and semiconductor devices.

16) A method for forming an electronic device using utilizing microencapsulated electrically active material, comprising the steps of: providing a substrate having a top surface for providing a support structure upon which components can be manufactured by a microcapsule printing method; attracting a layer of field attractive microcapsules to a discrete location of the substrate, the field attractive microcapsules comprising electrically reactive material whereby a predetermined electronic circuit component may be formed depending the composition and dimensions of the layer of field attractive microcapsules.

17) A method of forming an electronic device according to claim 16; wherein the electrically active material has the electrical properties of at least one of a conductor, insulator, resistor, semiconductor, inductor, magnetic material, piezoelectric material, optoelectrical material, or thermoelectric material.

18) A method of forming an electronic device according to claim 16; wherein the layer of field attractive microcapsules has multiple levels of microcapsules to form a desired three dimensional shape so that the electronic circuit component has electrical properties dependent on the composition of the multiple levels of the built up microcapsule layer and the dimensions of the three dimensional shape.
